(19) United States
(12) Patent Application Publication
(10) Pub. No.: US 2025/0124367 A1
(43) Pub. Date: Apr. 17, 2025

(54) ENTERPRISE RESOURCE PLANNING SYSTEM WITH SUPPORT FOR INTERORGANIZATION SERVICE ORDER

(71) Applicant: SAP SE, Walldorf (DE)

(72) Inventors: Michael Vollmer, Leimen (DE); Michael Witte, Dossenheim (DE)

(21) Appl. No.: 18/381,447

(22) Filed: Oct. 18, 2023

Related U.S. Application Data
(60) Provisional application No. 63/543,561, filed on Oct. 11, 2023.

(51) Int. Cl. G06Q 10/0631; H04L 9/40

(52) U.S. Cl. CPC G06Q 10/0631; H04L 63/10

(57) ABSTRACT

Various examples described herein are directed to systems and methods involving a database management system programmed to maintain a first database comprising data associated with a first organization of a business enterprise and a second database comprising data associated with a second organization of the business enterprise. An enterprise resource planning application may be programmed to access a source service order data structure from the first database. The source service order data structure describing a source service order to be completed by the first organization, the source service order data structure comprising an identifier of the first organization, and service item data describing at least one service item to be performed to complete the source service order. The enterprise resource planning application may generate a first inter-organization service order data structure describing a first inter-organization service order to be completed by the second organization.

### CROSS-REFERENCE TO RELATED APPLICATIONS

This application claims the benefit of U.S. Provisional Application No. 63/543,561, filed Oct. 11, 2023, entitled “ENTERPRISE RESOURCE PLANNING SYSTEM WITH SUPPORT FOR INTERORGANIZATION SERVICE ORDER,” which is incorporated herein by reference in its entirety.

### BACKGROUND

A database management system (DBMS) can be implemented as part of a suite of software applications that execute together. For example, the DBMS may support various client processes that utilize the DBMS to manage data. In some examples, a DBMS is implemented with a suite of processes that implement an enterprise resource planning (ERP) software application. ERP applications are often used in conjunction with a DBMS to manage various different aspects of business operations. An example ERP software application is the S/4 HANA product available from SAP SE of Walldorf, Germany.

The ERP application generates and utilizes the data stored at the database management system to perform different enterprise operations. For example, an ERP application supporting a human resources operation may store employee records at the DBMS. The ERP application supporting human resources management may perform various tasks related to, for example, using data managed by the DBMS to generate and manage payroll, benefits, and the like. An ERP application supporting accounting may use records managed by the DBMS to perform various accounting-related tasks such as generating and recording invoices, purchase orders, and the like. Other ERP applications may perform other business tasks. An ERP application supporting operations may use records managed by the DBMS to plan various services and service items performed, for example, on behalf of enterprise customers.

### BRIEF DESCRIPTION OF DRAWINGS

The present disclosure is illustrated by way of example and not limitation in the following figures.

FIG. 1 is a diagram showing one example of an environment comprising a computing system executing an ERP arrangement for multiple organizations that are part of a common enterprise.

FIG. 2 is a diagram showing an example source inter-organization service order data structure and corresponding inter-organization service order data structures.

FIG. 3 is a flow chart showing one example of a process flow that may be executed in the environment of FIG. 1 to create and process an inter- organization service order data structure.

FIG. 4 is a flow chart showing one example of a process flow that may be executed in the environment of FIG. 1 when a new service item is added to a source service order.

FIG. 5 is a flow chart showing one example of a process flow that may be executed in the environment of FIG. 1 to handle service item completion in conjunction with a source service order data object and at least one associated inter-organization service order data object.

FIG. 6 is a diagram showing one example of a workflow 600 for the creation and lifecycle management of an inter-organization service order data structure.

FIG. 7 is a block diagram showing one example of an architecture for a computing device.

FIG. 8 is a block diagram of a machine in the example form of a computer system within which instructions may be executed for causing the machine to perform any one or more of the methodologies discussed herein.

### DETAILED DESCRIPTION

In various examples, an ERP application, such as an operations ERP application, may utilize service order data structures stored at a DBMS. A service order data structure may store various data describing one or more service items. A service item is an operation that is to be performed by an enterprise.

In some examples, a service order data structure may include service item data describing one or more service items as well as other data that may be used to account for the service items such as, for example, an organization that is to perform the service item, a customer on whose behalf the service item or items are performed, cost or price information indicating the cost or price of the service item or items. The service order data structure may be used by the operations ERP application to manage logistics of the service items. In some examples, the service order data structure may also be used by an accounting ERP application to distribute costs and revenue for the associated service items, for example, by creating or modifying other data structures at the DBMS, such as, accounts payable, invoices, accounts receivable and/or the like.

Consider an example in which an enterprise is retained on behalf of an external customer to install a piece of industrial equipment. The operations ERP application may be used to generate a service order data structure at the DBMS describing the service item or items (e.g., associated with the installation of the piece of equipment), an indication of an organization within the enterprise that is to perform the service, an indication of the customer, and/or the like. The operations ERP application may be configured to manage the lifecycle of the service order. In some examples, the operations ERP application utilizes the service order data item to schedule performance of the various service items, order parts or materials for performing the various service items, arrange for delivery of the parts or materials for performing the various service items, arrange for the arrival of appropriate personnel at a plant or other location for performing the various service items, and/or the like.

The operations ERP application may also manage the status of one or more service items. For example, the operations ERP application receives an indication that a service item has been completed. In response, the operations ERP application may trigger the generation of invoices, accounts receivable, and/or the based on the price or cost data and the indication of the customer stored at the service order data structure.

In some examples, an enterprise utilizing DBMS and ERP applications may be arranged into different organizations. Each organization may represent a separate business unit such as, for example, a division, a subsidiary, and/or the like. In some examples, different organizations within a common enterprise have facilities at different geographic locations. In some examples, different organizations within a common enterprise may be engaged in different lines of business. For example, one organization may be in the business of selling industrial equipment while another organization within the same enterprise may be in the business of maintaining industrial equipment.

When an enterprise includes multiple organizations, it is sometimes desirable to segregate data for the different organizations. For example, different organizations within a common enterprise may maintain separate accounting data, separate human resources data, separate price data describing products and/or services provided by the organization, and/or the like. It may also be desirable to restrict inter-organization access to the data stored at the DBMS. This can be accomplished by restricting the authorization of user accounts associated with one organization of an enterprise to prevent those user accounts from accessing data for other organizations from the DBMS. Data segregation between organizations of a common enterprise can be accomplished in various different ways such as, for example, by storing data from different organizations at different DBMSs, different tenancies with a common cloud DBMS, and/or the like.

Segregating data from different organizations within a common enterprise can address concerns regarding data access, but it can create other challenges. For example, it is sometimes desirable for one organization within an enterprise to perform a service for another organization within the same enterprise. When the ERP data for the different enterprises is segregated, data security concerns may prevent a user associated with one organization from using the operations ERP application to generate a service order data structure at the DBMS (or portion thereof) associated with another organization.

In some examples, the operations ERP application is programmed to manage intra-enterprise services using a purchase order data structure. For example, a user account associated with a first organization may prompt to the creation of a purchase order data structure describing the service item to be performed by a second organization in a common enterprise. The purchase order data structure may be generated at the DBMS of the first organization, the organization receiving the service. The workflow performed by the operations ERP application for the purchase order data structure may include generating a purchase order that is provided to the second organization, for example, similar to the way that an external order would be made to a third-party enterprise. The second organization may receive the purchase order and the ERP application may treat it similar to a purchase order from an external customer.

This arrangement may increase the workload of the enterprise's computer systems as they will manage both sides of the transaction. For example, after receiving the purchase order, a service order data structure may be created at the DBMS associated with the second organization and the operations ERP application (e.g., an instance associated with the second organization) may manage the lifecycle of the service order data structure. Upon completion of the lifecycle of the service order data structure at the providing organization, the operations ERP application may close the service order data structure by marking relevant service items complete and may trigger the generation of an invoice and/or other operations to account for the cost or price of the performed service. In this way, the operations ERP application is performing additional operations, such as, for example, creating the purchase order data structure, sending a purchase order to the providing organization, and/or processing the purchase order on behalf of the providing organization.

Various examples address these and other challenges utilizing an inter-organization utility. The inter-organization utility may execute as an ERP application, as a component of an operations ERP application or other ERP application, and/or as part of a suite of ERP applications. The inter-organization utility may be programmed to distribute one or more service items from a service order data structure at the DBMS of a first organization to the DBMS of a second organization of a common enterprise. A user account associated with the first organization may prompt the creation of a source service order data structure describing one or more service items. The user account may prompt the inter-organization utility to distribute a portion of the one or more service items to the second organization. In response, the inter-organization utility may generate the inter-organization utility order data structure at the DBMS of the second organization.

The inter-organization utility may be configured with authorizations to create inter-organization service order data structures without being limited by the authorization privileges of the user account that generated the corresponding source service order data structure. In this way, user accounts from one organization may be empowered to generate service order data structures at other organizations of the common enterprise without providing the user accounts with full access to the data of the other organization.

The inter-organization utility may further manage the lifecycle of the source service order data structure and of the inter-organization service order data structure. For example, the inter-organization utility may receive an indication when a service item is completed by the second organization. In response, the inter-organization utility may mark the corresponding service item complete at the inter-organization service order data structure and at the source service order data structure. The inter-organization utility may also create various accounting-related data structures at the various DBMSs of the organizations. For example, the inter-organization utility may create an accounts receivable data structure at the DBMS of the second organization, an invoice data structure at the DBMS of the second organization and directed to the DBMS of the first organization, an accounts payable data structure at the DBMS of the first organization, and/or the like. In this way, inter-organization services may be tracked and accounted for by the ERP system without additional processing load associated with treating the inter-organization service as an external purchase.

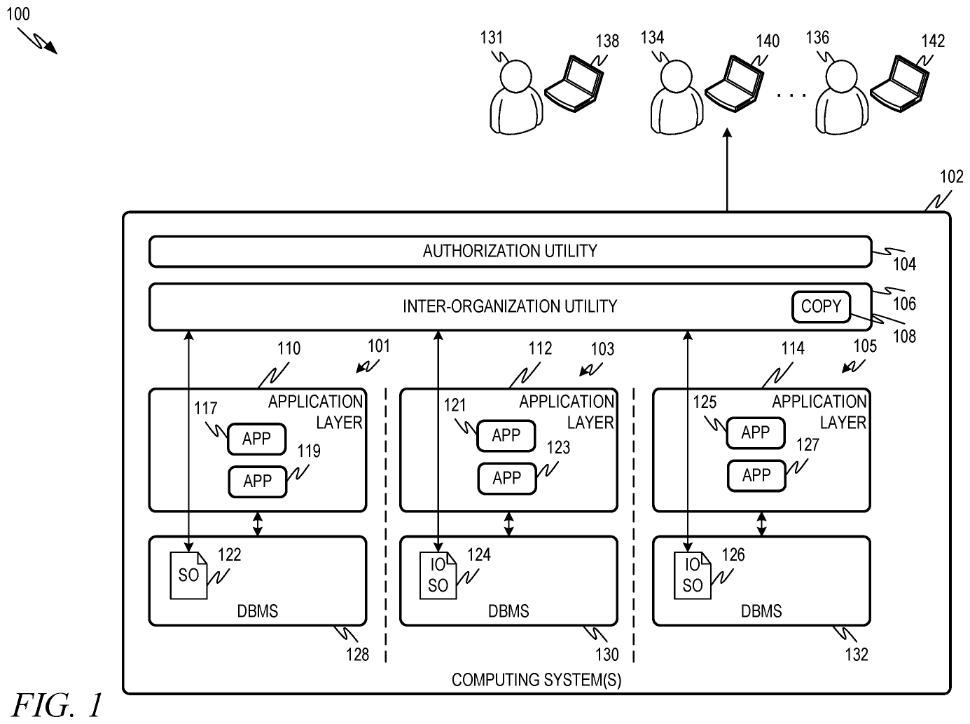

FIG. 1 is a diagram showing one example of an environment 100 comprising a computing system 102 executing an ERP arrangement for multiple organizations that are part of a common enterprise. The environment 100 includes a computing system 102 that implements DBMSs 128, 130, 132, application layers 110, 112, 114, and utilities 104, 106 for a number of organizations within a common enterprise.

In the example of FIG. 1, the computing system 102 implements DBMSs 128, 130, 132 and application layers 110, 112, 114 for three different organizations 101, 103, 105 within a common enterprise. Each respective application layer 110, 112, 114 comprises a set of one or more ERP application instances 117, 119, 121, 123, 125, 127. Each ERP application instance 117, 119, 121, 123, 125, 127 may execute to manage the DBMS 128, 130, 132 of the corresponding organization 101, 103, 105 and/or perform other ERP operations.

Users 131, 134, 136 may access the computing system 102 to interact with the ERP application layers 110, 112, 114. Each user 131, 134, 136 may be associated with a user account. A user's user account may be used to determine the authorization of the user. For example, the computing system 102 may implement an authorization utility 104. The authorization utility 104 may manage access of the user accounts of different users 131, 134, 136 to resources of the different organizations 101, 103, 105.

In some examples, users 131, 134, 136 may utilize user computing devices 138, 140, 142 to communicate with the computing system 102. User computing devices 138, 140, 142 may be and/or include various different types of computing devices such as, for example, desktop computers, laptop computers, tablet computers, mobile computing devices, and/or the like. It will be appreciated, that in some on-premise applications, a user may access the computing system 102 directly via input/output components of the computing system 102 such as, for example, a keyboard and/or a monitor. In some examples, a user 131, 134, 136 provides credentials to the authorization utility 104 via respective user computing devices 138, 140, 142. Based on the credentials, the authorization utility 104 may authorize a user account to perform various different operations at one or more of the respective organizations 101, 103, 105.

The computing system 102 may be implemented in an on-premise environment and/or in a cloud environment. In an on-premise environment, the enterprise including the organizations 101, 103, 105 may maintain the computing system 102 at one or more on-premise locations. In some examples, the DBMSs 128, 130, 132 are maintained as separate instances of a common DBMS application and/or storage. In other examples, the DBMSs 128, 130, 132 may be maintained as different partitions of a common DBMS instance. Also, the ERP application instances 117, 119, 121, 123, 125, 127 may be executed as separate instances of common ERP applications and/or may be common instances of ERP applications instance 117, 119, 121, 123, 125, 127 configured to separately support different organizations 101, 103, 105.

In other examples, the computing system 102 is implemented by one or more servers and/or other computing devices maintained by a cloud provider and accessible remotely. In a private cloud environment, the enterprise using the computing system 102 may provide applications, implement storage, and/or the like to implement the DBMSs 128, 130, 132, application layers 110, 112, 114, and utilities 104, 106. In a public cloud environment, a cloud provider may maintain the computing system 102 and provide a number of tenancies. The cloud provider may provide and maintain executables to implement the DBMSs 128, 130, 132, application layers 110, 112, 114, and utilities 104, 106. An enterprise may purchase a tenancy to permit users associated with that enterprise to access the computing system 102 to use the DBMSs 128, 130, 132, application layers 110, 112, 114, and utilities 104, 106. In some examples, data segregation may be achieved by separating the components associated with different organizations 101, 103, 105 into separate tenancies. The utilities 104, 108 may execute across tenancies, for example, with access to the DBMSs 128, 130, 132 and/or communication to the application instances 117, 119, 121, 123, 125, 127 across organizations 101, 103, 105.

FIG. 1 shows a source service order data structure 122 created at the DBMS 128 of the organization 101. For example, the source service order data structure 122 is generated by an ERP application instance 117, 119 of the organization 101 in response to a request from a user account having authorization privileges at the organization 101. For example, a user 131, 134, 136 may provide prudential data to the authorization utility 104 to access the privileges of a corresponding user account. The user account generating the source service order data structure 122 may not have authorization privileges at elements of the other organizations 103, 105. For example, the user account generating the source service order data structure 122 may request view or otherwise access to one or more of the inter-organization service order data structures 124, 126. The authorization utility 104 or other suitable component may be configured to deny the users request unless the user possesses separate privileges for accessing the respective DBMSs 130, 132.

The source service order data structure 122 may comprise an identifier of the organization 101 and service item data describing at least one service item to be performed, for example, on behalf of a customer of the enterprise. The inter-organization utility 106 may be an ERP application that is configured to distribute a service item or service item component from the source service order data structure 122 to one or more of the organizations 103, 105. In this example, the inter-organization utility 106 is configured to generate a first inter-organization service order data structure 124 including service item data describing at least one of the service items from the source service order data structure 122 at the DBMS 130 of the organization 103 and a second inter-organization service order data structure 126 including service item data describing at least one of the service items from the source service order data structure 122 at the DBMS 132 of the organization 105. In some examples, the inter-organization utility utilizes a copy utility 108 to generate the respective inter-organization service order data structures 124, 126, as described herein.

In some examples, the second inter-organization service order data structure 126 may be generated from the source service order data structure 122. Also, in some examples the second inter-organization service order data structure 126 may be generated from the inter-organization service order data structure 124. In this way, the inter-organization service order data structure 124 may act as a source service order data structure with respect to the second inter-organization data structure 126. In this example, the various arrangements described herein for processing source and inter-organization service order data structures may be applied with respect to the first inter-organization service order data structure 124 and the second inter-organization service order data structure 126, with the inter-organization service order data structure 124 being treated as a source service order data structure.

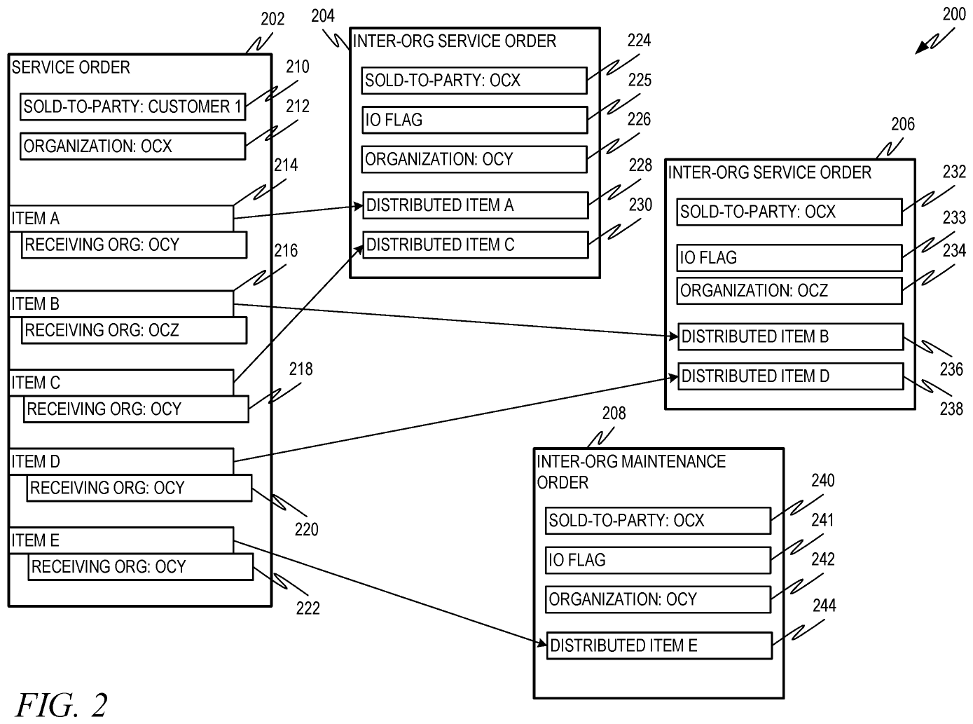

FIG. 2 is a diagram 200 showing an example source inter-organization service order data structure 202 and corresponding inter-organization service order data structures 204, 206, 208. The arrangement shown in FIG. 2 is one example arrangement of the respective data structures 202, 204, 206, 208. It will be appreciated that different arrangements of source service order data structures and inter-organization service order data structures are contemplated and may be used. For example, the arrangement of the diagram 200 includes three inter-organization service order data structures 204, 206, 208 corresponding to a single source service order data structure 202. In various implementations, there may be more or fewer than three inter-organization service order data structures corresponding to a single source service order data structure.

The example source service order data structure 202 of FIG. 2 comprises a sold-to-party field 210 describing a party for whom the service items by the source service order data structure 202 will be performed. In this example, the source service order data structure 202 indicates the sold-to-party as a customer of the enterprise. The source service order data structure 202 also comprises an organization identifier field 212 identifying the source organization associated with the source service order data structure 202. The source organization may be the organization that owns the DBMS where the service order data structure 202 is stored. Also, for example, a user account associated with the source organization may have generated the service order data structure 202. In the example of FIG. 2, the source organization is identified by an organizational code OCX.

The source service order data structure also includes service item data describing, in this example, five service items, item A at field 214, item B at field 216, item C at field 218, item D at field 220 and item E at field 222. In this example, the inter-organization utility 106 has distributed the service items A, B, C, D, E to other organizations indicated by organization identifiers OCY and OCZ. In this example, the fields 214, 216, 218, 220, 222 of the item data at the source service order data structure 202 indicate the organizations to which the respective service items have been distributed.

Inter-organization service order data structure 204 may have been generated by the inter-organization utility 106 and stored at a DBMS associated with the organization indicated by organization identifier OCY. The inter-organization service order data structure 204 comprises a sold-to-party field 224 indicating the source organization OCX. The inter-organization service order data structure 204 also comprises an inter-organization flag 225 indicating that the data structure is an inter-organization service order data structure. An organization field 226 indicates that the inter-organization data structure 204 is associated with (and is to be performed by) an organization OCY. The inter-organization service order data structure 204 also comprises item data at fields 228, 230. Field 228 includes a description of distributed item A, which has been distributed from item A of the source service order data structure 204. Field 230 includes a description of distributed item C, which has been distributed from item C of the source service order data structure 204.

Inter-organization order data structure 206 is stored at a DBMS associated with the organization indicated by organization identifier OCZ. The inter-organization service order data structure 206 comprises sold-to-party field 232 indicating the source organization OCX. The inter-organization service order data structure 206 also comprises an inter-organization flag 233 indicating that the data structure is an inter-organization service order data structure. An organization field 234 indicates that the inter-organization data structure 206 is associated with (and is to be performed by) an organization OCZ. The inter-organization service order data structure 206 also comprises item data at fields 236, 238. Field 236 includes a description of distributed item B, which has been distributed from item B of the source service order data structure 206. Field 236 includes a description of distributed item D, which has been distributed from item D of the source service order data structure 206.

FIG. 2 also shows an inter-organization service order data structure 208 that comprises an indicator of a maintenance order. A maintenance order may have a workflow different to that of other service orders and, in some examples, is associated with a maintenance agreement between organizations and/or between an organization and a customer. The inter-organization maintenance order is associated with the organization OCY. The inter-organization service order data structure 208 comprises sold-to-party field 240 indicating the source organization OCX. The inter-organization service order data structure 208 also comprises an inter-organization flag 241 indicating that the data structure is an inter-organization service order data structure. An organization field 242 indicates that the inter-organization data structure 208 is associated with (and is to be performed by) the organization OCY. The inter-organization service order data structure 208 also comprises item data at field 244. Field 244 includes a description of distributed item E, which has been distributed from item E of the source service order data structure 208.

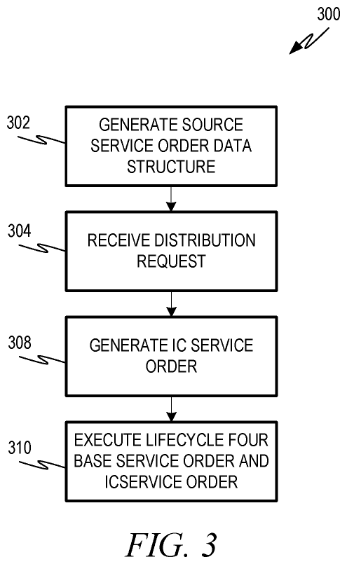

FIG. 3 is a flow chart showing one example of a process flow 300 that may be executed in the environment 100 of FIG. 1 to create and process an inter-organization service order data structure. The process flow 300, in some examples, is performed by the inter-organization utility 106. In some examples, some or all of the process flow 300 is performed by an application layer entity such as, for example, one or more of the ERP application instances 117, 119, 121, 123, 125, 127.

At operations 302, a source service order data structure is generated. The source service order data structure may be generated at a DBMS of a source organization. In some examples, the source service order data structure is generated in response to a request from a user account associated with the source organization. The user account may provide an indication of one or more service items that are to be described by the service item data of the source service order data structure.

In some examples, the request to generate the source service order data structure may include an indication that one or more service items indicated will be distributed to other organizations within the common enterprise. The inter-organization utility 106 may be configured to analyze the service items included or to be included in the source service order data item to determine whether the service items may be distributed and, if so, to which organizations the service items may be distributed.

At operations 304, the inter-organization utility 106, or other suitable component, may receive a distribution request. The distribution request may originate from a user account also associated with the source organization. In some examples, the distribution request may be received with the request to generate the source service order data structure. Also, in some examples, the distribution request may be received from the same user account that requested the generation of the source service order data structure.

Responsive to the distribution request, the inter-organization utility 106 may, at operation 308, generate an inter-organization service order data structure at the DBMS associated with a second organization to which one or more of the service items is to be distributed. As described herein, the inter-organization utility 106 may configure the inter-organization service order data structure to include an inter-organization flag or other indicator that the data structure is an inter-organization service order and that its workflow should be handled accordingly.

The creation of the inter-organization service order data structure may be arranged to proceed even in situations where the user account requesting its creation lacks authorization privileges to create service order data structures at the DBMS of the second organization. For example, the authorization utility 104 may be programmed to provide the inter-organization utility 106 with authorization to access the respective DBMSs 128, 130, 132 inter-organization service order data structures.

In some examples, the inter-organization service order data structure is generated using a copy utility 108 of the inter-organization utility 106. The copy utility 108 may be programmed to copy a subset of the fields from the source service order data structure to generate the inter-organization service order data structure. Copied fields may include, a product and quantity associated with the service item, such as, a requested start date, a planned start date, a requested end date, and a planned end date, service notes, reference objects, product configurations, item attachments, and/or the like. The copy utility 108 may be configured to generate a data exchange container comprising portions of the source service order data structure that are to be copied at the inter-organization service order data structure.

At operation 310, the inter-organization utility 106 may execute a lifecycle for the source service order data structure and the inter-organization service order data structure. This may include, for example, tracking the completion of service items included in the source service order data structure and distributed to the inter-organization service order data structure. It may also include generating various invoices and/or other accounting-related documents and data structures, as described herein. Examples for executing the lifecycle of an inter-organization service order data structure are provided herein, for example, with respect to FIGS. 1 and 4-6.

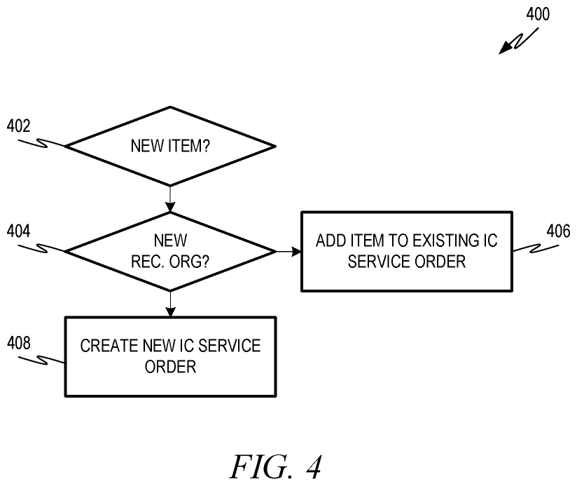

FIG. 4 is a flow chart showing one example of a process flow 400 that may be executed in the environment 100 of FIG. 1 when a new service item is added to a source service order. The process flow 400 is one example operation that may be part of executing a lifecycle for a source service order data structure and one or more inter-organization service order data structures. The process flow 400, in some examples, is performed by the inter-organization utility 106. In some examples, some or all of the process flow 400 is performed by an application layer entity such as, for example, one or more of the ERP application instances 117, 119, 121, 123, 125, 127.

At operation 402, the inter-organization utility 106 may receive an indication that a new service item is to be added to a source service order data structure. The new service item may be added, for example, by a user account associated with the source organization. In some examples, the user account associated with the new service item may be the same user account that created the source service order data structure. Also, in some examples, the new item may be received with a distribution request requesting that the new service item be distributed to another organization.

At operation 404, the inter-organization utility 106 may determine whether the new service item is to be performed by a new organization or by an organization that has already been the recipient of a previous inter-organization service order data object associated with the source service order data object. If the recipient organization is not new, then, at operation 406, the inter-organization utility 106 may add the new service item to an existing inter-organization service order data object at a DBMS of the existing recipient organization. If the recipient organization is new and does not yet have an inter-organization service order data structure associated with the source service order data structure, then the inter-organization utility 106, at operation 408, may create a new inter-organization service order data object at a DBMS of the new recipient organization.

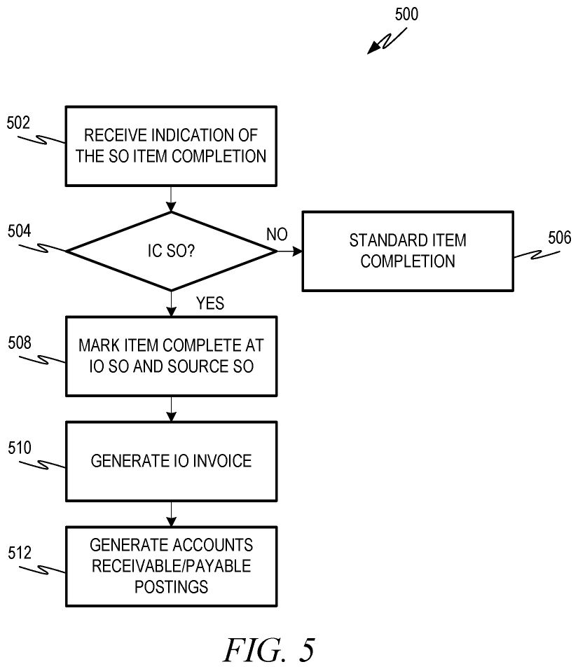

FIG. 5 is a flow chart showing one example of a process flow 500 that may be executed in the environment 100 of FIG. 1 to handle service item completion in conjunction with a source service order data object and at least one associated inter-organization service order data object. The process flow 500 is one example operation that may be part of executing a lifecycle for a source service order data structure and one or more inter-organization service order data structures. The process flow 500, in some examples, is performed by the inter-organization utility 106. In some examples, some or all of the process flow 500 is performed by an application layer entity such as, for example, one or more of the ERP application instances 117, 119, 121, 123, 125, 127.

At operation 502, and operations ERP application instance at an organization may receive an indication that a service item has been completed. The indication may be received from a user account associated with the organization that performed the service item. For example, a user 131, 134, 136 associated with the organization that performed the service item may access an operations ERP application instance 117, 119, 121, 123, 125, 127, also associated with the organization, and provided indication that the service item has been completed.

At operation 504, the operations ERP application instance 117, 119, 121, 123, 125, 127 may determine whether the service order data structure associated with the completed service item is an inter-organization service order data structure. This may include examining a service order data structure indicated by the completed service item to determine whether it includes an inter-organization flag or other indicator of an inter-organization service order data structure.

If the service order data structure associated with the completed service item is not an inter-organization service order data structure, then the operations ERP application instance 117, 119, 121, 123, 125, 127 may execute a standard service item completion workflow at operation 506. This may include marking the service item as completed and performing any suitable generation of invoices, accounts receivable, and/or the like.

If the service order data structure associated with the completed service item is an inter-organization service order data structure, then the service item may, at operation 508, be marked as complete at the inter-organization service order data structure and at the source service order data structure. In some examples, the operations ERP application instance 117, 119, 121, 123, 125, 127 may cause the service item to be marked as complete at the inter- organization service order data structure and may call the inter-organization utility 106 to mark the service item complete at the source service order data structure.

At operation 510, the inter-organization utility 106 may generate an inter-organization invoice. The inter-organization invoice is an invoice data structure that is provided from the service-performing organization to the source organization prompting the source organization to pay for the service item that has been completed. At operation 512, the inter-organization utility 106 may generate, or cause to be generated, appropriate accounts receivable and accounts payable postings associated with the completed service item. For example, an accounts receivable data object may be posted to the DBMS associated with the organization that performed the service item. An accounts payable item may be posted to the DBMS associated with the source organization. In some examples, the accounts payable item may be formatted to be or include an IDoc container, for example, utilized by the S/4 HANA product available from SAP SE of Walldorf, Germany.

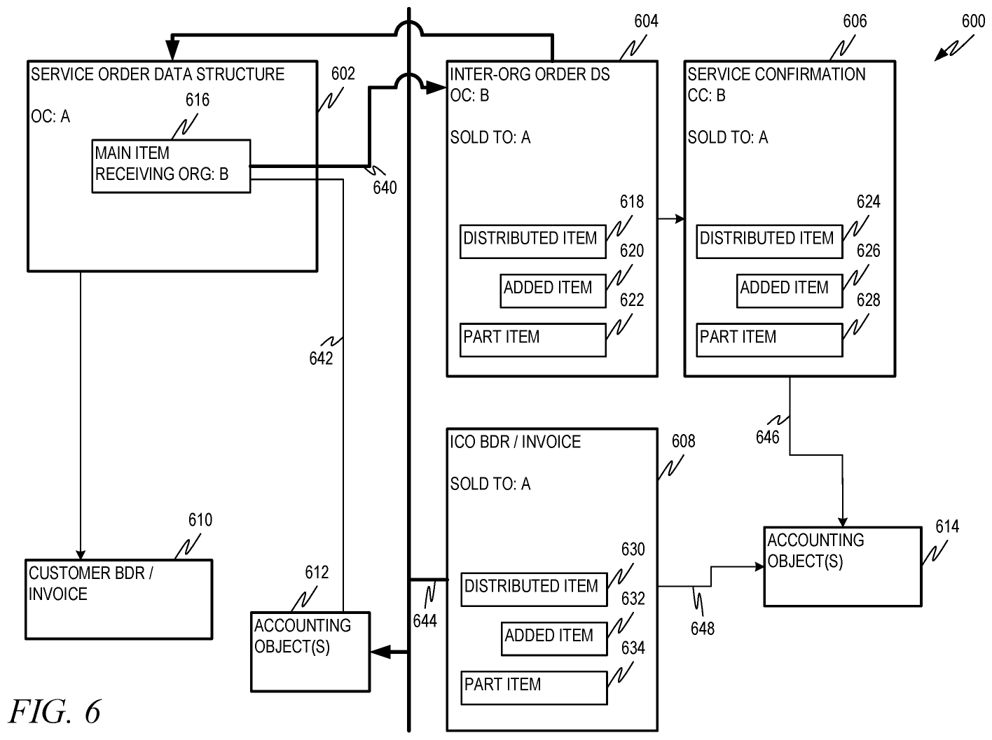

FIG. 6 is a diagram showing one example of a workflow 600 for the creation and lifecycle management of an inter-organization service order data structure. In various examples, the workflow 600 may be performed in the environment 100 of FIG. 1. Initially, the source service order data structures 602 may be generated, for example, at a DBMS of a source organization. The source service order data structure 602 may be generated, for example, based on a request from a user account associated with the source organization.

The source service order data structure 602 may comprise an indicator of the source organization, in this example the letter “A,” and item data indicating a main service item 616. In some examples, the main service item includes data indicating that the main service item 616 is to be distributed to another organization. Also, in some examples, the main service item 616 may include data indicating an identity of the organization to which the main service item 616 is to be distributed. In this example, the receiving organization is indicated by “B.”

When the inter-organization service order data structure 602 is complete, an inter-organization service order data structure 604 may, at operation 640, be generated at a DBMS associated with the receiving organization. In addition, an accounting object 612 may be generated at operation 642. The accounting object 612 may indicate an account payable postings that will be made to the DBMS of the source organization, for example, upon completion of the main service item 616. The inter-organization service order data structure 602, in some examples, may be visible to user accounts associated with the source organization.

The inter-organization service order data structure 604 may indicate an organization code or other identifier of the receiving organization B. It may also indicate that the organization A is the “sold to” party for the service order. The intercompany service order data structure 604 may include item data describing a distributed service item 618, which may be equivalent to the main service item 616. In this example, the inter-organization service order data structure 604 also includes data item describing an added item 620 and a part item 622. The added item 620 may be an item associated with the main service item 616 that was added, for example, by a user account associated with the receiving organization. This may reflect, for example, a service that is subsidiary to but part of the main distributed service item 618. The part item 622 may describe a part that is or was used to perform the main service item 616/distributed service item 618.

A service confirmation data structure 606 may be generated, at operation 644, for example, upon receiving confirmation that the distributed service item 618 has been completed. The service confirmation data structure 606 may be similar to the inter-organization service order data structure 604 and may indicate the receiving organization B, the source organization A, and the service items that were completed, in this case, an indication of a distributed service item 624 corresponding to the distributed service item 618 and the main service item 616, and added service item 626 corresponding to the added item 620, and a part item 628 corresponding to the part item 622.

The creation of the service confirmation data structure 606 may trigger a release of the inter-organization service order data structure 604 billing. This may prompt the inter-organization utility 106 and/or an appropriate ERP instance 117, 119, 121, 123, 125, 127 to generate an invoice data structure 608 at operation 644. The invoice data structure 608 may be similar to the inter-organizational service order data structure 604 and may indicate the receiving organization B, the source organization A, and the service items that were completed, in this case, an indication of a distributed service item 630 corresponding to the distributed service item 618 and the main service item 616, and added service item 632 corresponding to the added item 620, and a part item 634 corresponding to the part item 622.

The invoice data structure 608 may prompt to the creation of an accounting object 614 from the invoice data structure 608 (path 648) and the service confirmation data structure 606 (path 646). The accounting object 614 may be generated to record costs to the receiving organization associated with completion of the items 64, 626, 628 as well as revenue received or to be received via an accounts payable generated at accounting object 612. In addition, a customer invoice data structure 610 may be generated. The customer invoice data structure 610 may prompt the provision of an invoice to the customer of the source service order data structure 602.

### EXAMPLES

Example 1 is a computing system comprising at least one processor programmed to execute: a database management system programmed to maintain a first database comprising data associated with a first organization of a business enterprise and a second database comprising data associated with a second organization of the business enterprise; and an enterprise resource planning application, the enterprise resource planning application being programmed to perform operations comprising: accessing a source service order data structure from the first database, the source service order data structure describing a source service order to be completed by the first organization, the source service order data structure comprising an identifier of the first organization, and service item data describing at least one service item to be performed to complete the source service order; accessing distribution request data, the distribution request data describing a request from a first user account that a first service item of the at least one service item be distributed for completion by the second organization, the first user account being associated with authorization privileges to access the first database; generating a first inter-organization service order data structure describing a first inter-organization service order to be completed by the second organization, the first inter-organization service order data structure comprising an identifier of the second organization, inter-organization indicator data, and service item data describing the first service item; and storing the first inter-organization service order data structure to the second database, the first user account lacking authorization privileges to access the second database.

In Example 2, the subject matter of Example 1 optionally includes the operations further comprising: receiving, from the first user account, a view request requesting at least a portion of the first inter-organization service order data structure; and denying the view request.

In Example 3, the subject matter of any one or more of Examples 1-2 optionally includes the operations further comprising: accessing an indication that the first service item has been completed by the second organization; and responsive to the indication that the first service item has been completed by the second organization, modifying the source service order data structure to indicate that the first service item has been completed.

In Example 4, the subject matter of Example 3 optionally includes the operations further comprising generating an accounts receivable posting at the second database, the accounts receivable posting indicating the first organization to pay the accounts receivable posting.

In Example 5, the subject matter of any one or more of Examples 3-4 optionally includes the operations further comprising generating an accounts payable posting at the first database, the accounts payable posting indicating the second organization as a recipient of the accounts payable posting.

In Example 6, the subject matter of any one or more of Examples 1-5 optionally includes the operations further comprising: accessing new service item request data describing a request from the first user account to add a second service item to the service item data of the source service order data structure, the new service item request data indicating that the second organization is to complete the second service item; and modifying the first inter-organization service order data structure to includes a description of the second service item.

In Example 7, the subject matter of any one or more of Examples 1-6 optionally includes the operations further comprising: accessing new service item request data describing a request from the first user account to add a second service item to the service item data of the source service order data structure, the new service item request data indicating that a third organization is to complete the second service item; and generating a second inter-organization service order data structure describing a second inter-organization service order to be completed by the third organization, the second inter-organization service order data structure comprising an identifier of the third organization, inter-organization indicator data, and service item data describing the second service item.

In Example 8, the subject matter of any one or more of Examples 1-7 optionally includes the generating of the first inter-organization service order data structure comprising executing a copy utility, the copy utility configured to copy a subset of fields from the source service order to the first inter-organization service order, the subset of fields comprising a requested start date for the first service item and a requested end date for the first service item.

Example 9 is a method for enterprise resource planning using a database management system programmed to maintain a first database comprising data associated with a first organization of a business enterprise and a second database comprising data associated with a second organization of the business enterprise, the method comprising: accessing a source service order data structure from the first database, the source service order data structure describing a source service order to be completed by the first organization, the source service order data structure comprising an identifier of the first organization, and service item data describing at least one service item to be performed to complete the source service order; accessing distribution request data, the distribution request data describing a request from a first user account that a first service item of the at least one service item be distributed for completion by the second organization, the first user account being associated with authorization privileges to access the first database; generating a first inter-organization service order data structure describing a first inter-organization service order to be completed by the second organization, the first inter-organization service order data structure comprising an identifier of the second organization, inter-organization indicator data, and service item data describing the first service item; and storing the first inter-organization service order data structure to the second database, the first user account lacking authorization privileges to access the second database.

In Example 10, the subject matter of Example 9 optionally includes receiving, from the first user account, a view request requesting at least a portion of the first inter-organization service order data structure; and denying the view request.

In Example 11, the subject matter of any one or more of Examples 9-10 optionally includes accessing an indication that the first service item has been completed by the second organization; and responsive to the indication that the first service item has been completed by the second organization, modifying the source service order data structure to indicate that the first service item has been completed.

In Example 12, the subject matter of Example 11 optionally includes generating an accounts receivable posting at the second database, the accounts receivable posting indicating the first organization to pay the accounts receivable posting.

In Example 13, the subject matter of any one or more of Examples 11-12 optionally includes generating an accounts payable posting at the first database, the accounts payable posting indicating the second organization as a recipient of the accounts payable posting.

In Example 14, the subject matter of any one or more of Examples 9-13 optionally includes accessing new service item request data describing a request from the first user account to add a second service item to the service item data of the source service order data structure, the new service item request data indicating that the second organization is to complete the second service item; and modifying the first inter-organization service order data structure to includes a description of the second service item.

In Example 15, the subject matter of any one or more of Examples 9-14 optionally includes accessing new service item request data describing a request from the first user account to add a second service item to the service item data of the source service order data structure, the new service item request data indicating that a third organization is to complete the second service item; and generating a second inter-organization service order data structure describing a second inter-organization service order to be completed by the third organization, the second inter-organization service order data structure comprising an identifier of the third organization, inter-organization indicator data, and service item data describing the second service item.

In Example 16, the subject matter of any one or more of Examples 9-15 optionally includes the generating of the first inter-organization service order data structure comprising executing a copy utility, the copy utility configured to copy a subset of fields from the source service order to the first inter-organization service order, the subset of fields comprising a requested start date for the first service item and a requested end date for the first service item.

Example 17 is a non-transitory machine-readable medium comprising instructions thereon that, when executed by at least one processor, because the at least one processor to perform operations comprising: accessing a database management system programmed to maintain a first database comprising data associated with a first organization of a business enterprise and a second database comprising data associated with a second organization of the business enterprise; accessing a source service order data structure from a first database, the source service order data structure describing a source service order to be completed by the first organization, the source service order data structure comprising an identifier of the first organization, and service item data describing at least one service item to be performed to complete the source service order; accessing distribution request data, the distribution request data describing a request from a first user account that a first service item of the at least one service item be distributed for completion by the second organization, the first user account being associated with authorization privileges to access the first database; generating a first inter-organization service order data structure describing a first inter-organization service order to be completed by the second an identifier of the second organization, inter-organization indicator data, and service item data describing the first service item; and storing the first inter-organization service order data structure to the second database, the first user account lacking authorization privileges to access the second database.

In Example 18, the subject matter of Example 17 optionally includes receiving, from the first user account, a view request requesting at least a portion of the first inter-organization service order data structure; and denying the view request.

In Example 19, the subject matter of any one or more of Examples 17-18 optionally includes accessing an indication that the first service item has been completed by the second organization; and responsive to the indication that the first service item has been completed by the second organization, modifying the source service order data structure to indicate that the first service item has been completed.

In Example 20, the subject matter of Example 19 optionally includes generating an accounts receivable posting at the second database, the accounts receivable posting indicating the first organization to pay the accounts receivable posting.

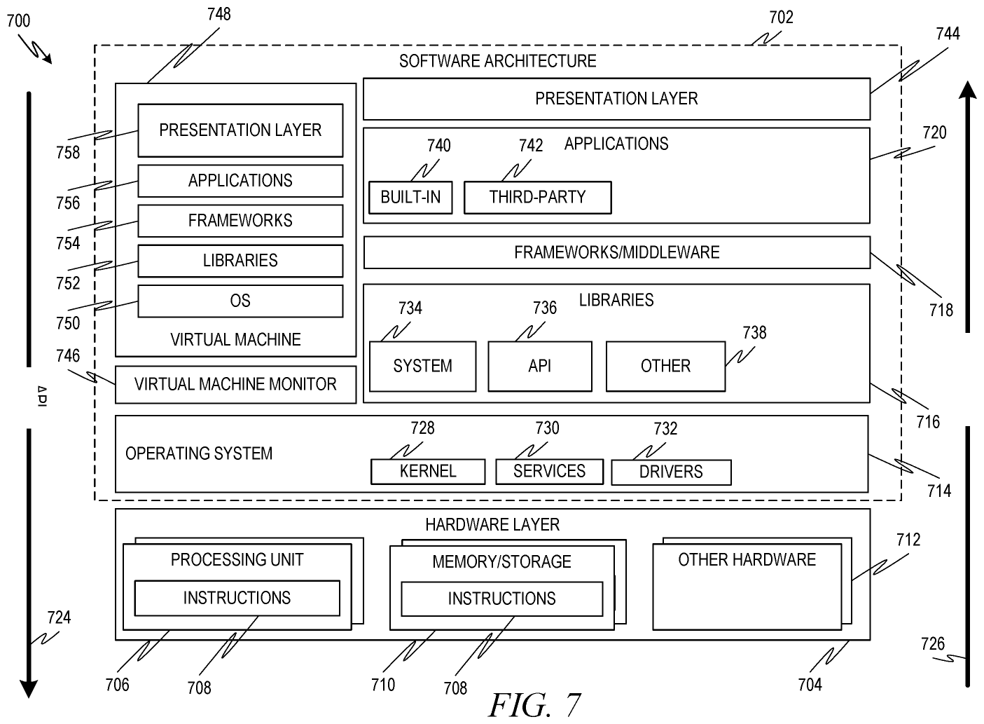

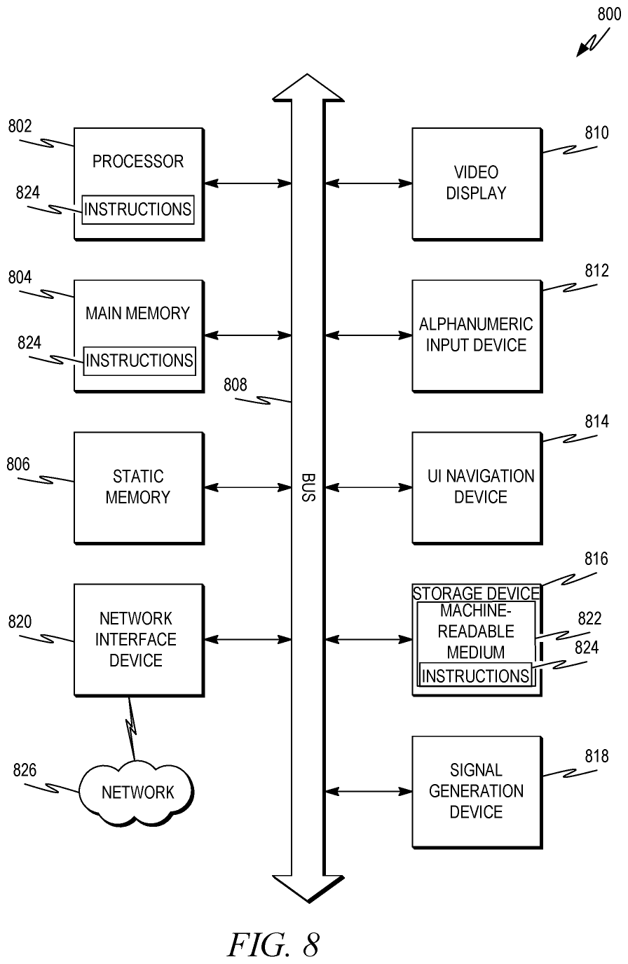

FIG. 7 is a block diagram 700 showing one example of a software architecture 702 for a computing device. The software architecture 702 may be used in conjunction with various hardware architectures, for example, as described herein. FIG. 7 is merely a non-limiting example of a software architecture and many other architectures may be implemented to facilitate the functionality described herein. A representative hardware layer 704 is illustrated and can represent, for example, any of the above referenced computing devices. In some examples, the hardware layer 704 may be implemented according to the architecture of the computer system of FIG. 8.

The representative hardware layer 704 comprises one or more processing units 706 having associated executable instructions 708. Executable instructions 708 represent the executable instructions of the software architecture 702, including implementation of the methods, modules, subsystems, and components, and so forth described herein and may also include memory and/or storage modules 710, which also have executable instructions 708. Hardware layer 704 may also comprise other hardware as indicated by other hardware 712 which represents any other hardware of the hardware layer 704, such as the other hardware illustrated as part of the architecture 702.

In the example architecture of FIG. 7, the software architecture 702 may be conceptualized as a stack of layers where each layer provides particular functionality. For example, the software architecture 702 may include layers such as an operating system 714, libraries 716, middleware layer 718, applications 720, and presentation layer 744. Operationally, the applications 720 and/or other components within the layers may invoke API calls 724 through the software stack and access a response, returned values, and so forth illustrated as messages 726 in response to the API calls 724. The layers illustrated are representative in nature and not all software architectures have all layers. For example, some mobile and/or special purpose operating systems may not provide a middleware layer 718, while others may provide such a layer. Other software architectures may include additional and/or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. In some examples, the services 730 include an interrupt service. The interrupt service may detect the receipt of an interrupt and, in response, cause the architecture 702 to pause its current processing and execute an interrupt service routine (ISR) when an interrupt is accessed.

The drivers 732 may be responsible for controlling and/or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than to interface directly with the underlying operating system 714 functionality (e.g., kernel 728, services 730 and/or drivers 732). The libraries 716 may include system 734 libraries (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The middleware layer 718 (also sometimes referred to as frameworks) may provide a higher-level common infrastructure that may be utilized by the applications 720 and/or other software components/modules. For example, the middleware layer 718 may provide various graphic user interface (GUI) functions, high-level resource management, high-level location services, and so forth. The middleware layer 718 may provide a broad spectrum of other APIs that may be utilized by the applications 720 and/or other software components/modules, some of which may be specific to a particular operating system and/or platform.

The applications 720 include built-in applications 740 and/or third-party applications 742. Examples of representative built-in applications 740 may include, but are not limited to, a contacts application, a browser application, a book reader application, a location application, a media application, a messaging application, and/or a game application. Third-party applications 742 may include any of the built-in applications 740 as well as a broad assortment of other applications. In a specific example, the third-party application 742 (e.g., an application developed using the Android™ or iOST software development kit (SDK) by an entity other than the vendor of the particular platform) may be mobile software running on a mobile operating system such as iOS™, Android™, Windows® Phone, or other mobile computing device operating systems. In this example, the third-party application 742 may invoke the API calls 724 provided by the mobile operating system such as operating system 714 to facilitate functionality described herein.

The applications 720 may utilize built-in operating system functions (e.g., kernel 728, services 730 and/or drivers 732), libraries (e.g., system 734, API libraries 736, and other libraries 738), and middleware layer 718 to create user interfaces to interact with users of the system. Alternatively, or additionally, in some systems interactions with a user may occur through a presentation layer, such as presentation layer 744. In these systems, the application/module “logic” can be separated from the aspects of the application/module that interact with a user.

Some software architectures utilize virtual machines. In the example of FIG. 7, this is illustrated by virtual machine 748. A virtual machine creates a software environment where applications/modules can execute as if they were executing on a hardware computing device. A virtual machine is hosted by a host operating system (operating system 714) and typically, although not always, has a virtual machine monitor 746, which manages the operation of the virtual machine as well as the interface with the host operating system (i.e., operating system 714). A software architecture executes within the virtual machine such as an operating system 750, libraries 752, frameworks/middleware 754, applications 756 and/or presentation layer 758. These layers of software architecture executing within the virtual machine 748 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 8 is a block diagram of a machine in the example form of a computer system 800 within which instructions 824 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 800 includes a processor 802 (e.g., a central processing unit (CPU), a graphics processing unit (GPU), or both), a main memory 804, and a static memory 806, which communicate with each other via a bus 808. The computer system 800 may further include a video display unit 810 (e.g., a liquid crystal display (LCD) or a cathode ray tube (CRT)). The computer system 800 also includes an alphanumeric input device 812 (e.g., a keyboard or a touch-sensitive display screen), a user interface navigation (or cursor control) device 814 (e.g., a mouse), a disk drive unit 816, a signal generation device 818 (e.g., a speaker), and a network interface device 820.

### Machine-Readable Medium

The disk drive unit 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804 and/or within the processor 802 during execution thereof by the computer system 800, with the main memory 804 and the processor 802 also constituting machine-readable media 822.

While the machine-readable medium 822 is shown in an example embodiment to be a single medium, the term “machine-readable medium” may include a single medium or multiple media (e.g., a centralized or distributed database, and/or associated caches and servers) that store the one or more instructions 824 or data structures. The term “machine-readable medium” shall also be taken to include any tangible medium that is capable of storing, encoding, or carrying instructions 824 for execution by the machine and that cause the machine to perform any one or more of the methodologies of the present disclosure, or that is capable of storing, encoding, or carrying data structures utilized by or associated with such instructions 824. The term “machine-readable medium” shall accordingly be taken to include, but not be limited to, solid-state memories, and optical and magnetic media. Specific examples of machine-readable media 822 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

### Transmission Medium

The instructions 824 may further be transmitted or received over a communications network 826 using a transmission medium. The instructions 824 may be transmitted using the network interface device 820 and any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 824 for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1. A computing system comprising at least one processor programmed to execute:
a database management system programmed to maintain a first database comprising data associated with a first organization of a business enterprise and a second database comprising data associated with a second organization of the business enterprise; and
an enterprise resource planning application, the enterprise resource planning application being programmed to perform operations comprising:
accessing a source service order data structure from the first database, the source service order data structure describing a source service order to be completed by the first organization, the source service order data structure comprising an identifier of the first organization, and service item data describing at least one service item to be performed to complete the source service order;
accessing distribution request data, the distribution request data describing a request from a first user account that a first service item of the at least one service item be distributed for completion by the second organization, the first user account being associated with authorization privileges to access the first database;
generating a first inter-organization service order data structure describing a first inter-organization service order to be completed by the second organization, the first inter-organization service order data structure comprising an identifier of the second organization, inter-organization indicator data, and service item data describing the first service item; and
storing the first inter-organization service order data structure to the second database, the first user account lacking authorization privileges to access the second database.

2. The computing system of claim 1, the operations further comprising:
receiving, from the first user account, a view request requesting at least a portion of the first inter-organization service order data structure; and
denying the view request.

3. The computing system of claim 1, the operations further comprising:
accessing an indication that the first service item has been completed by the second organization; and
responsive to the indication that the first service item has been completed by the second organization, modifying the source service order data structure to indicate that the first service item has been completed.

4. The computing system of claim 3, the operations further comprising generating an accounts receivable posting at the second database, the accounts receivable posting indicating the first organization to pay the accounts receivable posting.

5. The computing system of claim 3, the operations further comprising generating an accounts payable posting at the first database, the accounts payable posting indicating the second organization as a recipient of the accounts payable posting.

6. The computing system of claim 1, the operations further comprising:
accessing new service item request data describing a request from the first user account to add a second service item to the service item data of the source service order data structure, the new service item request data indicating that the second organization is to complete the second service item; and
modifying the first inter-organization service order data structure to include a description of the second service item.

7. The computing system of claim 1, the operations further comprising:
accessing new service item request data describing a request from the first user account to add a second service item to the service item data of the source service order data structure, the new service item request data indicating that a third organization is to complete the second service item; and
generating a second inter-organization service order data structure describing a second inter-organization service order to be completed by the third organization, the second inter-organization service order data structure comprising an identifier of the third organization, inter-organization indicator data, and service item data describing the second service item.

8. The computing system of claim 1, the generating of the first inter-organization service order data structure comprising executing a copy utility, the copy utility configured to copy a subset of fields from the source service order to the first inter-organization service order, the subset of fields comprising a requested start date for the first service item and a requested end date for the first service item.

9. A method for enterprise resource planning using a database management system programmed to maintain a first database comprising data associated with a first organization of a business enterprise and a second database comprising data associated with a second organization of the business enterprise, the method comprising:
accessing a source service order data structure from the first database, the source service order data structure describing a source service order to be completed by the first organization, the source service order data structure comprising an identifier of the first organization, and service item data describing at least one service item to be performed to complete the source service order;
accessing distribution request data, the distribution request data describing a request from a first user account that a first service item of the at least one service item be distributed for completion by the second organization, the first user account being associated with authorization privileges to access the first database;
generating a first inter-organization service order data structure describing a first inter-organization service order to be completed by the second an identifier of the second organization, inter-organization indicator data, and service item data describing the first service item; and
storing the first inter-organization service order data structure to the second database, the first user account lacking authorization privileges to access the second database.

10. The method of claim 9, further comprising:
receiving, from the first user account, a view request requesting at least a portion of the first inter-organization service order data structure; and
denying the view request.

11. The method of claim 9, further comprising:
accessing an indication that the first service item has been completed by the second organization; and
responsive to the indication that the first service item has been completed by the second organization, modifying the source service order data structure to indicate that the first service item has been completed.

12. The method of claim 11, further comprising generating an accounts receivable posting at the second database, the accounts receivable posting indicating the first organization to pay the accounts receivable posting.

13. The method of claim 11, further comprising generating an accounts payable posting at the first database, the accounts payable posting indicating the second organization as a recipient of the accounts payable posting.

14. The method of claim 9, further comprising:
accessing new service item request data describing a request from the first user account to add a second service item to the service item data of the source service order data structure, the new service item request data indicating that the second organization is to complete the second service item; and
modifying the first inter-organization service order data structure to include a description of the second service item.

15. The method of claim 9, further comprising:
accessing new service item request data describing a request from the first user account to add a second service item to the service item data of the source service order data structure, the new service item request data indicating that a third organization is to complete the second service item; and
generating a second inter-organization service order data structure describing a second inter-organization service order to be completed by the third organization, the second inter-organization service order data structure comprising an identifier of the third organization, inter-organization indicator data, and service item data describing the second service item.

16. The method of claim 9, the generating of the first inter-organization service order data structure comprising executing a copy utility, the copy utility configured to copy a subset of fields from the source service order to the first inter-organization service order, the subset of fields comprising a requested start date for the first service item and a requested end date for the first service item.

17. A non-transitory machine-readable medium comprising instructions thereon that, when executed by at least one processor, because the at least one processor to perform operations comprising:
accessing a database management system programmed to maintain a first database comprising data associated with a first organization of a business enterprise and a second database comprising data associated with a second organization of the business enterprise;
accessing a source service order data structure from a first database, the source service order data structure describing a source service order to be completed by the first organization, the source service order data structure comprising an identifier of the first organization, and service item data describing at least one service item to be performed to complete the source service order;
accessing distribution request data, the distribution request data describing a request from a first user account that a first service item of the at least one service item be distributed for completion by the second organization, the first user account being associated with authorization privileges to access the first database;
generating a first inter-organization service order data structure describing a first inter-organization service order to be completed by the second organization, the first inter-organization service order data structure comprising an identifier of the second organization, inter-organization indicator data, and service item data describing the first service item; and
storing the first inter-organization service order data structure to the second database, the first user account lacking authorization privileges to access the second database.

18. The non-transitory machine-readable medium of claim 17, further comprising:
receiving, from the first user account, a view request requesting at least a portion of the first inter-organization service order data structure; and
denying the view request.

19. The non-transitory machine-readable medium of claim 17, further comprising:
accessing an indication that the first service item has been completed by the second organization; and
responsive to the indication that the first service item has been completed by the second organization, modifying the source service order data structure to indicate that the first service item has been completed.

20. The non-transitory machine-readable medium of claim 19, further comprising generating an accounts receivable posting at the second database, the accounts receivable posting indicating the first organization to pay the accounts receivable posting.
